(19) United States
(12) Patent Application Publication
(10) Pub. No.: US 2007/0133753 A1
(43) Pub. Date: Jun. 14, 2007

(54) Mobile x-ray acquisition apparatus

(76) Inventors: Rudolf Jakob, Uttenreuth (DE); Manfred Rattner, Grossenseebach (DE); Holger Schmidt, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/603,487

(22) Filed: Nov. 22, 2006

(30) Foreign Application Priority Data
Nov. 25, 2005 (DE) 10 2005 056 247.7

(51) Int. Cl. H05G 1/02

(52) U.S. Cl. 378/198

(57) ABSTRACT

A mobile x-ray acquisition system has a cart on which is arranged an articulated arm that has a free end at which an x-ray source is carried. Also arranged on the cart is an image evaluation device. An image storage medium can be inserted into the image evaluation device. The image storage medium contains image information generated by an x-ray exposure, and the image information stored in the image storage medium can be imported into the image evaluation device and evaluated therein.

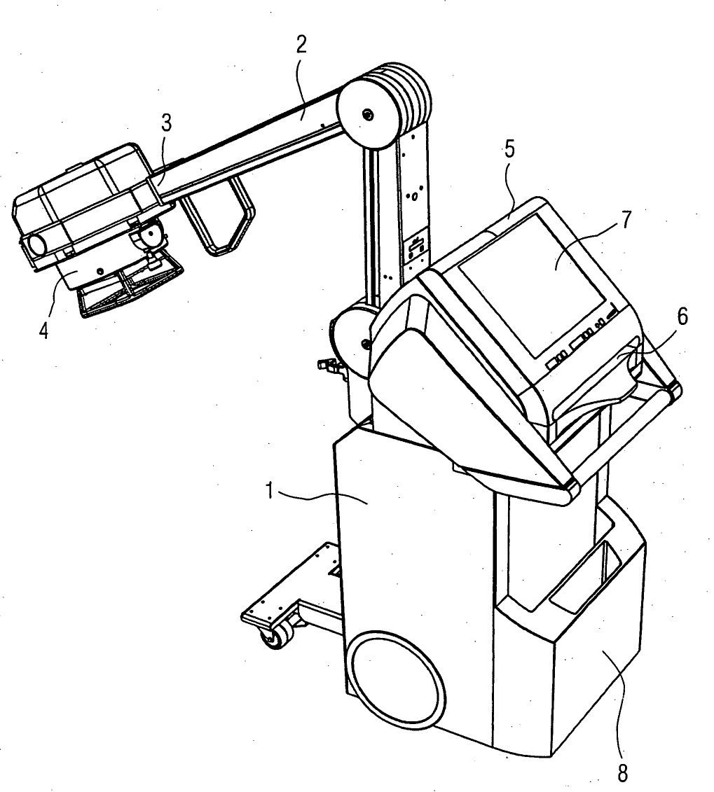

### BACKGROUND OF THE INVENTION

1. Field of the Invention

The present invention concerns a mobile x-ray acquisition system.

2. Description of the Prior Art

A mobile x-ray acquisition apparatus is known, for example, from DE 196 27 657 C2. This known x-ray acquisition apparatus has a cart on which are arranged a first articulated arm and a second articulated arm. The first articulated arm has a free end at which an x-ray source is carried. The second articulated arm has a free end at which a planar detector is carried. The x-ray source and the planar detector can be adjusted three-dimensionally in space. The planar detector is formed of a matrix of detector elements based on amorphous silicon. The detector signals are transmitted to image electronics via a line (conductor) contained in the second articulated arm. Since the planar detector can only be positioned by the second articulated arm and by the mobility of the cart, cases can occur in which an optimal imaging is possible only with great effort and/or only in a limited manner.

### SUMMARY OF THE INVENTION

An object of the present invention is to provide a mobile x-ray acquisition system that allows low-expenditure and reliable imaging, in particular given a recumbent patient.

The object is inventively achieved by a mobile x-ray acquisition system having a cart on which is arranged an articulated arm that carriers, at its free end, an x-ray source, with an image evaluation device also being arranged on the cart. An image storage medium is insertable into the image evaluation device. This image storage medium contains image information generated by an x-ray exposure. The image information stored in the image storage medium can be imported into the image evaluation device and evaluated therein.

In the inventive x-ray system the positioning of the image storage medium is possible independently of the positioning of the x-ray source. For example, given a recumbent patient the image storage medium merely need to be positioned under said patient. The cart of the x-ray system is then subsequently moved up to a longitudinal side or up to a front side of the patient bed, and the x-ray source is aligned for the following x-ray acquisition. A reliable imaging can therewith be achieved in a simple manner with the mobile x-ray system according to, even given a recumbent patient.

The image evaluation device of the mobile x-ray system in accordance with the invention allows the importation of the image information generated by the x-ray exposure to be stored in the image storage medium, thereby facilitating a subsequent evaluation of the imported image information. The workflow thus is significantly simplified in the production of an x-ray image.

In an embodiment of the mobile x-ray acquisition system, the image evaluation device includes a monitor. A prompt (real time) assessment of the x-ray image by a physician or operating personnel is thereby possible.

The image storage medium is preferably a storage film, in particular a cassette with storage film (film cassette). In this case the image information present in the storage film is read out therefrom and imported into and digitized in the image evaluation device. Such film cassettes exhibit a lower weight relative to planar detectors and thus are particularly simple to handle. Moreover, a greater selection of various sizes is available for film cassettes.

Given the use of a storage film as the storage medium, a CR computed radiography) reader is used as an image evaluation device. The analog image information stored in the storage film is imported into the CR reader and digitized by the CR reader.

In the context of the invention other image storage media are also possible that allow the image information to be read out in a comparable manner and, if applicable, digitized as well as evaluated.

A further improvement in the workflow is achieved in an embodiment wherein the image information imported into the image evaluation device and/or the image information evaluated in the image evaluation device are transmitted to a recipient via a local network (LAN, local area network), in particular via a wireless local network (WLAN, wireless LAN). This allows at least a portion of the already-imported and/or evaluated image information from previously-acquired x-ray images to be transmitted to a central storage or to a central computer for possible further processing during the acquisition of a series of x-ray images.

### DESCRIPTION OF THE DRAWING

The single figure shows an exemplary embodiment of a mobile x-ray system according to the invention, in a perspective view.

### DESCRIPTION OF THE PREFERRED EMBODIMENTS

A cart of a mobile x-ray acquisition system is designated with 1 in the drawing. An articulated arm 2 is arranged in the cart 1 and has a free end 3 at which an x-ray source 4 is carried. According to the invention an image evaluation device 5, into which an image storage medium 6 can be inserted, is arranged on the cart 1 of the mobile x-ray acquisition system. The stored image information of the image storage medium 6 can be imported into the image evaluation device 5. The image information was generated in the image storage medium 6 during an x-ray exposure of an examination subject (patient). The image information read out from the image storage medium 6 and imported into the image evaluation device 5 is subsequently evaluated in the image evaluation device 5.

Voltage necessary for generation of the x-ray radiation is provided to the x-ray source 4 by a controlled voltage generator that is also arranged in the cart 1. The control electronics required for the activation of the x-ray generator is likewise arranged in the cart 1.

The image evaluation device 5 is preferably a CR reader and the image storage medium 6 is preferably a storage film, in particular a cassette with storage film. Such film cassettes exhibit a lower weight relative to planar detectors and are particularly simple to handle. Moreover, a large selection of various sizes is available for film cassettes.

In the shown embodiment of the inventive x-ray system, the image evaluation device 5 has a monitor 7 in the form of a touchscreen, with which at least a portion of the control (operating) elements for the mobile x-ray system can be presented and activated. A prompt assessment of the x-ray image by a physician or an operating personnel is thereby possible. A further x-ray image can be immediately generated if applicable.

In the embodiment of the inventive x-ray system shown in the drawing, on the front side facing away from the articulated arm 2 the cart 1 has a holder 8 for at least one further image storage medium 6. An exchange of the image storage medium 6 is thereby possible in a simple and fast manner.

Although modifications and changes may be suggested by those skilled in the art, it is the intention of the inventors to embody within the patent warranted hereon all changes and modifications as reasonably and properly come within the scope of their contribution to the art.

We claim as our invention:

1. A mobile x-ray image acquisition system comprising:
a mobile cart;
an articulated arm mounted on said mobile cart, said articulated arm having a free end;
an x-ray source mounted at said free end of said articulated arm;
an image evaluation device carried at said cart; and
an image storage medium removably insertable into said image evaluation device, said image storage medium containing image information generated by an x-ray exposure, said image information stored in said image storage medium being imported into said image evaluation device and evaluated therein after said image storage medium is inserted into said image evaluation device.

2. A mobile x-ray image acquisition system as claimed in claim 1 comprising a monitor mounted at said cart and electrically connected to said image evaluation device.

3. A mobile x-ray image acquisition system as claimed in claim 2 wherein said monitor comprises a touch screen.

4. A mobile x-ray imaging acquisition system as claimed in claim 1 wherein said storage medium comprises storage film.

5. A mobile x-ray image acquisition system as claimed in claim 4 wherein said image storage medium comprises a cassette containing said storage film.

6. A mobile x-ray image acquisition system as claimed in claim 4 wherein said image evaluation device is a CR reader.

7. A mobile x-ray image acquisition system as claimed in claim 1 comprising an interface at said cart to a local network (LAN) to allow at least a portion of the image information imported into the image evaluation device to be transmitted via said local network to a recipient remote from said cart.

8. A mobile x-ray image acquisition system as claimed in claim 1 comprising an interface at said cart to a wireless local network (WLAN) to allow at least a portion of the image information imported into the image evaluation device to be transmitted via said wireless local network to a recipient remote from said cart.

9. A mobile x-ray image acquisition system as claimed in claim 1 wherein said image evaluation device produces an evaluation result based on evaluation of the image information imported into said image evaluation device from said image storage medium, and comprising a local network (LAN) interface at said cart allowing transmission of said evaluation result via said local network to a recipient remote from said cart.

10. A mobile x-ray image acquisition system as claimed in claim 1 wherein said image evaluation device produces an evaluation result based on evaluation of the image information imported into said image evaluation device from said image storage medium, and comprising a wireless local network (WLAN) interface at said cart allowing transmission of said evaluation result via said wireless local network to a recipient remote from said cart.

11. A mobile x-ray image acquisition system as claimed in claim 1 comprising a holder at said cart for at least one additional image storage medium.

12. A mobile x-ray image acquisition system as claimed in claim 11 wherein said holder is disposed at a side of said cart facing away from said articulated arm.
